(19) United States
(12) Patent Application Publication
(10) Pub. No.: US 2026/0319406 A1
(43) Pub. Date: Oct. 15, 2026

(54) IMAGE FORMING APPARATUS FOR ADJUSTING TIMING FOR STARTING OR ENDING SUPPLY OF ELECTRIC CHARGE TO FIXING DEVICE

(71) Applicant: KYOCERA Document Solutions Inc., Osaka (JP)

(72) Inventor: Yuto MASAOKA, Osaka (JP)

(73) Assignee: KYOCERA Document Solutions Inc., Osaka (JP)

(21) Appl. No.: 19/639,772

(22) Filed: Apr. 6, 2026

(30) Foreign Application Priority Data
Apr. 10, 2025 (JP) 2025-065286

(51) Int. Cl. G03G 15/00; G03G 15/20

(52) U.S. Cl. CPC G03G 15/5004; G03G 15/2017; G03G 15/2064; G03G 15/80

(57) ABSTRACT

An image forming apparatus includes an image forming device, a fixing unit, a pressure unit, an electric charge supply device, and a control unit. The control unit functions as a controller and an identification device. The identification device identifies a leading or trailing end position of an image formed on a recording medium based on image data. The controller controls an amount of electric charge supplied by the electric charge supply device to adjust a timing at which the electric charge supply device starts supply of the electric charge to the fixing unit to match a timing at which a leading end of the image arrives at a fixing nip, or to adjust a timing at which the electric charge supply device stops the supply of the electric charge to the fixing unit to match a timing at which a trailing end of the image arrives at the fixing nip.

### INCORPORATION BY REFERENCE

This application claims priority to Japanese Patent Application No.2025-065286 filed on Apr. 10, 2025, the entire contents of which are incorporated by reference herein.

### BACKGROUND

The present disclosure relates to an image forming apparatus including a fixing device that thermally compresses an image formed on a recording medium such as recording paper.

An image forming apparatus such as an electrophotographic copying machine or a multifunction machine includes a fixing device that fixes a toner image formed (transferred) on a recording medium. The fixing device includes a fixing unit such as a fixing belt that comes into contact with a recording medium on which the toner image has been formed and heats the recording medium. In this type of image forming apparatus, a surface of the fixing unit may be charged to a polarity opposite to a charge polarity of toner due to contact with the recording medium. In this case, some of the toner on the recording medium passing through a contact point with the fixing unit may be transferred to a surface of the fixing unit, and the transferred toner may then be transferred to the next recording medium passing through the contact point, resulting in a problem known as electrostatic offset. For this reason, an image forming apparatus has been proposed that includes an electric charge supply device that is provided to face a contact surface of the fixing unit with the recording medium and supplies an electric charge of the same polarity as the charge polarity of the toner to the contact surface.

### SUMMARY

As one aspect of the present disclosure, a technique that further improves the above technique is proposed.

An image forming apparatus according to an aspect of the present disclosure includes an image forming device, a fixing unit, a pressure unit, an electric charge supply device, and a control unit. The image forming device forms a toner image on a recording medium based on image data. The fixing unit is provided to be rotatable and comes into contact with the recording medium on which the toner image is formed to heat the recording medium. The pressure unit forms a fixing nip between the fixing unit and the pressure unit, in which the recording medium is sandwiched and transported, and drives and rotates the fixing unit. The electric charge supply device is provided to face a contact surface of the fixing unit with the recording medium and supplies an electric charge having the same polarity as the charge polarity of the toner contained in the toner image to the contact surface. The control unit includes a processor, and functions as a controller and an identification device by the processor executing a control program. The controller controls an amount of electric charge supplied by the electric charge supply device and supplies an electric charge to the contact surface. The identification device identifies, based on the image data, a leading end position of an image formed on the recording medium located downstream in a transport direction of the recording medium relative to a leading end of the recording medium in the transport direction, or a trailing end position of the image formed on the recording medium located upstream in the transport direction of the recording medium relative to a trailing end of the recording medium in the transport direction. The controller controls an amount of electric charge supplied by the electric charge supply device to adjust a timing at which the electric charge supply device starts supply of the electric charge to the contact surface to match a timing at which the leading end position of the image identified by the identification device arrives at the fixing nip, or to adjust a timing at which the electric charge supply device stops the supply of the electric charge to the contact surface to match a timing at which the trailing end position of the image identified by the identification device arrives at the fixing nip.

### BRIEF DESCRIPTION OF THE DRAWINGS

FIG. 1 is a functional block diagram schematically showing a main internal configuration of an image forming apparatus.

FIG. 2 is a schematic side view showing an example of a fixing device included in the image forming apparatus.

FIG. 3 is an enlarged view showing a configuration of an electric charge supply device included in the fixing device.

FIG. 4 is a cross-sectional view seen from a direction IV in FIG. 3.

FIG. 5 is a diagram for describing blocks into which image data is divided.

FIG. 6 is a diagram showing an example of an image formed on a recording medium in terms of the number of dots.

FIG. 7A is a diagram showing an example of a change in a surface potential of a fixing belt at a fixing nip in a comparative example.

FIG. 7B is a diagram showing an example of a change in the surface potential of the fixing belt at the fixing nip in the embodiment.

FIG. 8 is a flowchart showing an example of processes performed by the control unit of the image forming apparatus.

FIG. 9 is a diagram showing an example of an image formed on a recording medium in terms of the number of dots.

### DETAILED DESCRIPTION

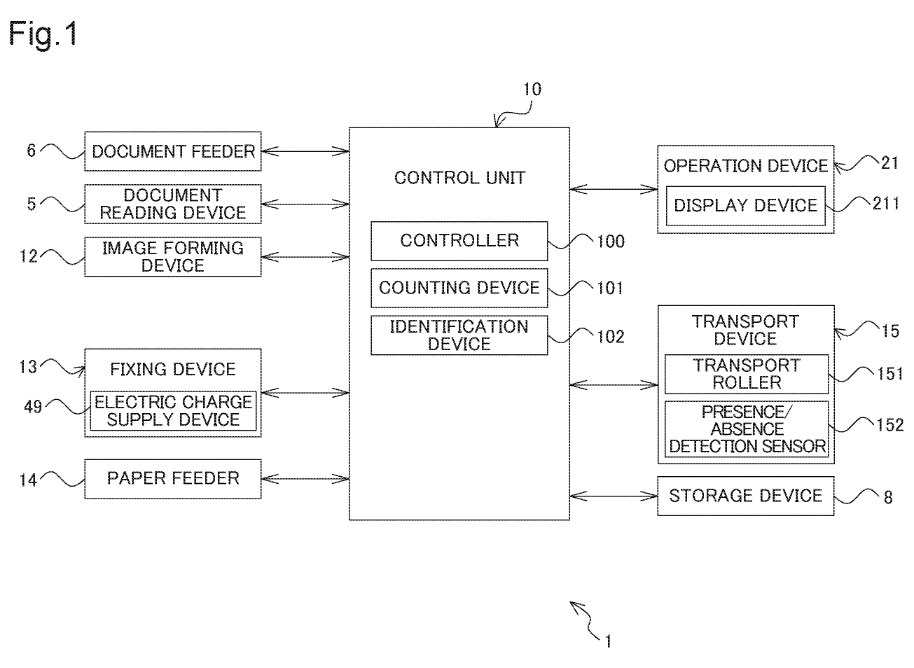

An image forming apparatus according to an embodiment of the present disclosure will be described below with reference to the drawings. FIG. 1 is a functional block diagram showing a schematic main internal configuration of an image forming apparatus according to an embodiment of the present disclosure. The image forming apparatus 1 is a multifunction machine that has multiple functions, such as a copy function, a printer function, a scanner function, and a facsimile function.

The image forming apparatus 1 includes a control unit 10, a document feeder 6, a document reading device 5, an image forming device 12, a fixing device 13, a paper feeder 14, a transport device 15, an operation device 21, and a storage device 8.

The document feeder 6 is configured to be openable and closable by a hinge or the like on a top surface of the document reading device 5. The document feeder 6 functions as a document pressing cover when a document placed on the platen glass is read. The document feeder 6 is an auto document feeder (ADF), and includes a document placement tray, and supplies a document placed on a document placement tray to the document reading device 5.

The document reading device 5 includes a scanner and reads a document fed from the document feeder 6 or reads a document placed on the platen glass. The document reading device 5 is capable of sequentially reading images of a plurality of documents fed from the document feeder 6.

A description will be given of a case in which a document reading operation is performed in the image forming apparatus 1. The document reading device 5 optically reads an image of a document supplied to the document reading device 5 by the document feeder 6 or a document placed on the platen glass, and generates image data. The image data generated by the document reading device 5 is stored in an image memory or the like.

The following describes a case in which the image forming operation is performed by the image forming apparatus 1. The image forming device 12 includes a photosensitive drum, a charging device, an exposure device, a developing device, and a primary transfer device for each color, and further includes a mechanism for forming an image on recording paper as a recording medium by secondary transfer via an intermediate transfer belt. The image forming device 12 forms an image (a toner image) on recording paper fed from the paper feeder 14 using, for example, positively charged toner based on image data generated by a document reading operation, image data stored in an image memory, or image data received from a network-connected computer, thereby creating a printed matter.

The fixing device 13 is a fixing device equipped with a heat roller, a pressure roller, and a drive mechanism for rotating the rollers, and heats and presses the recording paper on which an image has been formed by the image forming device 12 at a nip between the two rollers, thereby fixing the image onto the recording paper. The recording paper that has been subjected to the fixing process is discharged into a discharge tray. The fixing device 13 further includes an electric charge supply device 49 which will be described below.

The paper feeder 14 includes a paper feed cassette, a pickup roller that picks up recording paper from the paper feed cassette and feeds it to the image forming device 12, a transport roller, a transport path, and a rotation drive mechanism for each of the rollers.

The transport device 15 transports a plurality of recording media continuously along the transport path along which the recording media are transported. The transport device 15 includes a transport path that connects the paper feeder 14 to the discharge tray, a transport roller 151 provided at an appropriate position on the transport path, and a presence/absence detection sensor 152 that detects the presence or absence of a recording medium. The presence/absence detection sensor 152 is provided, for example, at a predetermined position upstream of the fixing device 13 in a transport direction. The presence/absence detection sensor 152 is, for example, an optical sensor, and detects a leading end of the recording medium that has arrived at the predetermined position in the transport direction of the recording medium.

The operation device 21 has various hard keys that are operated by a user, and receives instructions from the user, such as instructions to execute an image forming operation, regarding various operations and processes that can be executed by the image forming apparatus 1, in accordance with the operations of the hard keys.

The operation device 21 includes a display device 211 that displays operation guides and the like to the user. The operation device 21 receives input of instructions from the user via a touch panel of the display device 211 based on a user’s operation (a touch operation) on a screen displayed on the display device 211.

The display device 211 includes a liquid crystal display (LCD). When the user touches a button or key displayed on the screen, the touch panel receives an instruction corresponding to a touched position. In this case, the touch panel functions as the operation device.

The storage device 8 is a large-capacity storage device such as a hard disk drive (HDD) or a solid state drive (SSD), and stores various control programs and the like.

The control unit 10 includes a processor, a random access memory (RAM), a read-only memory (ROM), and a dedicated hardware circuit. The processor may be, for example, a central processing unit (CPU), an application specific integrated circuit (ASIC), or a micro processing unit (MPU).

The control unit 10 functions as a controller 100, a counting device 101, and an identification device 102 through the operation of the processor in accordance with a control program stored in the storage device 8. However, the controller 100 and the like may also be configured of hardware circuits, regardless of the operation in accordance with the control program by the control unit 10. Unless otherwise identified below, the same applies to each embodiment.

The controller 100 controls the overall operation of the image forming apparatus 1. The controller 100 is connected to the document feeder 6, the document reading device 5, the image forming device 12, the fixing device 13, the paper feeder 14, the transport device 15, the operation device 21, and the storage device 8, and controls the driving of each of them, and performs various processes necessary for image formation by the image forming apparatus 1.

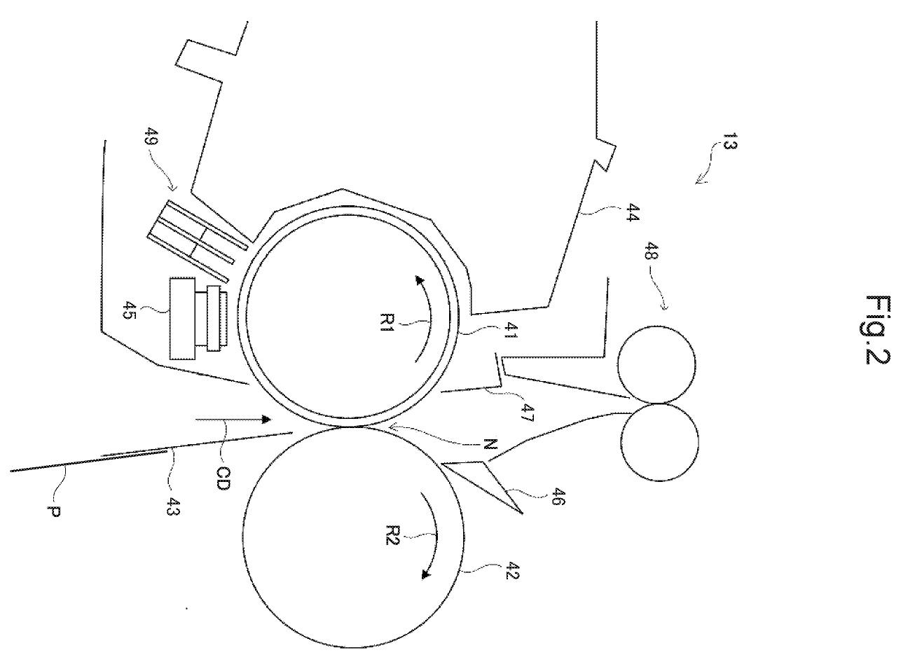

FIG. 2 is a schematic side view showing an example of the fixing device 13 included in the image forming apparatus 1. The fixing device 13 includes a fixing belt 41, a pressure roller 42, a pre-entry guide 43, a heater 44, a temperature sensor 45, a separation claw 46, a separation plate 47, a pair of discharge rollers 48, and the electric charge supply device 49.

The fixing belt 41 is an endless belt-like unit that comes into contact with a recording medium P onto which a toner image has been transferred, and heats the recording medium P. The fixing belt 41 is provided so as to be rotatable in a rotation direction R1 (counterclockwise in FIG. 2). The fixing belt 41 is an example of a fixing unit in the claims. The fixing unit may be a roller-shaped unit, or the like.

The fixing belt 41 has a base layer, an elastic layer, and a release layer. The base layer is made of a metal material such as nickel. The elastic layer is made of an elastic material such as silicone rubber. The release layer is made of a fluorine-based resin material such as PFA.

On the inside of the fixing belt 41, there are provided a belt guide unit that guides rotation of the fixing belt 41 in the rotation direction R1, and a pressing unit that presses the fixing belt 41 toward the pressure roller 42 side.

The pressure roller 42 is a roller-shaped unit that is provided in contact with the fixing belt 41 and applies pressure to the recording medium P that passes between the fixing belt 41 and the pressure roller 42. The pressure roller 42 is provided to be rotatable in a rotation direction R2 (clockwise in FIG. 2). A fixing nip N is formed between the fixing belt 41 pressed by the pressing unit and the pressure roller 42, and the recording medium P passing between the fixing belt 41 and the pressure roller 42 is sandwiched therebetween.

The pressure roller 42 has a metal core, an elastic layer, and a release layer. The metal core is made of a metal material such as aluminum. The elastic layer is made of an elastic material such as silicone sponge. The release layer is made of a fluorine-based resin material such as PFA.

The pressure roller 42 is rotatably supported by a casing of the fixing device 13. The pressure roller 42 receives a rotational driving force supplied from a driving device and rotates in the rotation direction R2. Thus, the fixing belt 41 is driven and rotated in the rotation direction R1. A propulsive force toward the downstream side in a transport direction CD is applied to the recording medium P passing through the fixing nip N. The pressure roller 42 is an example of a pressure unit in the claims.

The recording medium P on which the toner image is formed is heated and pressed by the fixing belt 41 and the pressure roller 42 when it passes through the fixing nip N. Thus, the toner image formed on the recording medium P is fixed to the recording medium P. The pre-entry guide 43 guides the recording medium P transported from the image forming device 12 (FIG. 1) to the fixing nip N.

The heater 44 heats the fixing belt 41. The heater 44 is provided to face a surface of the fixing belt 41. For example, the heater 44 is an IH fixing unit that inductively heats the fixing belt 41 due to an action of a magnetic flux generated by passing a current through a coil. The heater 44 may be a halogen heater or the like.

The temperature sensor 45 detects a temperature of the surface of the fixing belt 41. For example, the temperature sensor 45 is a non-contact thermistor that is provided at a distance from the fixing belt 41. The temperature sensor 45 outputs an electric signal corresponding to the detected temperature of the surface of the fixing belt 41. The electric signal output from the temperature sensor 45 is used by the controller 100 to control the driving of the heater 44.

The separation claw 46 separates the recording medium P that has passed through the fixing nip N from the pressure roller 42. The separation plate 47 separates the recording medium P that has passed through the fixing nip N from the fixing belt 41. The pair of discharge rollers 48 discharges the recording medium P that has passed through the fixing nip N toward a pair of paper ejection rollers.

The release layer that forms the surface of the fixing belt 41 is made of a fluorine-based resin material. Therefore the surface of the fixing belt 41 may be negatively charged, which is opposite to the charge polarity of the toner, due to contact with the pressure roller 42 and the recording medium P. When the surface of the fixing belt 41 is negatively charged, some of the toner on the recording medium P passing through the fixing nip N is transferred to the surface of the fixing belt 41, and a problem called electrostatic offset occurs in which the transferred toner is transferred to the next recording medium P passing through the fixing nip N. To solve this problem, the electric charge supply device 49, which will be described below, is provided in the image forming apparatus 1.

The electric charge supply device 49 is provided to face the surface (an example of a contact surface in the present disclosure) of the fixing belt 41. The electric charge supply device 49 supplies an electric charge of the same polarity as the charge polarity of the toner contained in the toner image formed on the recording medium P, that is, a positive polarity, to the surface of the fixing belt 41.

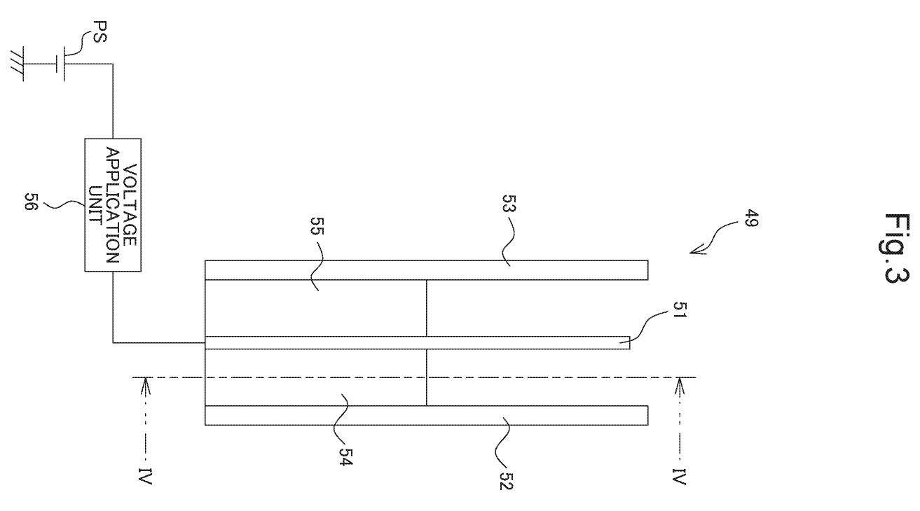

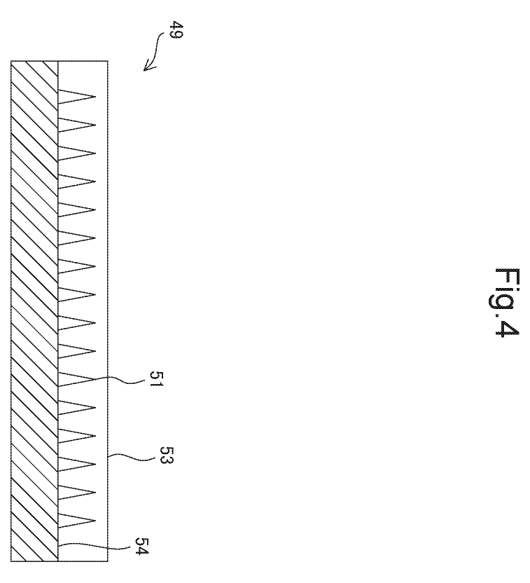

FIG. 3 is an enlarged view of the electric charge supply device 49. FIG. 4 is a cross-sectional view seen in a direction IV in FIG. 3. As shown in FIGS. 3 and 4, the electric charge supply device 49 includes an electric discharge electrode 51, a first ground electrode 52, a second ground electrode 53, a first insulating unit 54, a second insulating unit 55, and a voltage application unit 56.

The voltage application unit 56 is connected to a power supply PS, and supplies an applied voltage to the electric discharge electrode 51 using the power supplied from the power supply PS.

The electric discharge electrode 51 is connected to the voltage application unit 56, and an electric discharge is generated between the electric discharge electrode 51 and the fixing belt 41 by the voltage applied from the voltage application unit 56. The electric discharge electrode 51 is a sheet metal unit on which sawteeth are formed in a longitudinal direction (refer to FIG. 4). For example, the electric discharge electrode 51 is a SUS plate having a thickness of 0.1 mm (millimeter). The electric discharge electrode 51 is disposed in a position such that a longitudinal direction thereof is aligned with an axial direction of a rotation axis of the fixing belt 41 and tips of the sawtooth face the surface of the fixing belt 41. A predetermined gap is provided between the tips of the sawteeth of the electric discharge electrode 51 and the surface of the fixing belt 41 so that an electric discharge can be generated between the electric discharge electrode 51 and the surface of the fixing belt 41.

The first ground electrode 52 and the second ground electrode 53 stabilize the electric discharge that occurs between the electric discharge electrode 51 and the surface of the fixing belt 41. The first ground electrode 52 is a unit formed in a plate shape of a metal material. The second ground electrode 53 is a unit formed in the same manner as the first ground electrode 52.

The first ground electrode 52 and the second ground electrode 53 are provided to face each other with the electric discharge electrode 51 interposed therebetween. The first insulating unit 54 is provided between the electric discharge electrode 51 and the first ground electrode 52, and defines a gap between the electric discharge electrode 51 and the first ground electrode 52. The first insulating unit 54 is a plate-shaped unit made of a resin material.

A gap between the electric discharge electrode 51 and the first ground electrode 52 is defined by a plate thickness of the first insulating unit 54. The second insulating unit 55 that defines a gap between the electric discharge electrode 51 and the second ground electrode 53 is provided between the electric discharge electrode 51 and the second ground electrode 53. The second insulating unit 55 is a unit formed in the same manner as the first insulating unit 54. A gap between the electric discharge electrode 51 and the second ground electrode 53 is defined by a plate thickness of the second insulating unit 55.

The voltage application unit 56 uses the power supplied from the power supply PS to apply a voltage to the electric discharge electrode 51 so that a charging current A1 flowing through the electric discharge electrode 51 becomes a predetermined target current. At this time, the voltage application unit 56 applies a voltage of the same polarity as a charging property of the toner (the toner used to form an image in the image forming device 12) that constitutes the toner image to be fixed in the fixing device 13, that is, a positive polarity, to the electric discharge electrode 51.

An electric discharge is generated between the electric discharge electrode 51 and the surface of the fixing belt 41 by a voltage of the positive polarity applied by the voltage application unit 56. Thus, an electric charge of the positive polarity is supplied to the surface of the fixing belt 41, and the surface is positively charged. Thus, the transfer of the toner on the recording medium P passing through the fixing nip N to the surface of the fixing belt 41 is curbed.

The controller 100 shown in FIG. 1 controls an amount of electric charge supplied by the electric charge supply device 49. The electric charge supply device 49 supplies an electric charge to the surface of the fixing belt 41 under the control of the amount of supply of electric charge by the controller 100. For example, the controller 100 controls the voltage application unit 56 included in the electric charge supply device 49 to perform constant current control, and adjusts the voltage applied to the electric discharge electrode 51 so that the charging current A1 (a current value of the constant current control) supplied to the electric discharge electrode 51 becomes a predetermined target current value that generates a predetermined amount of electric charge to be supplied to the fixing belt 41. When the controller 100 does not cause the electric charge supply device 49 to supply the electric charge (when the amount of supply of the electric charge is set to 0), the controller 100 sets the charging current A1 to 0.

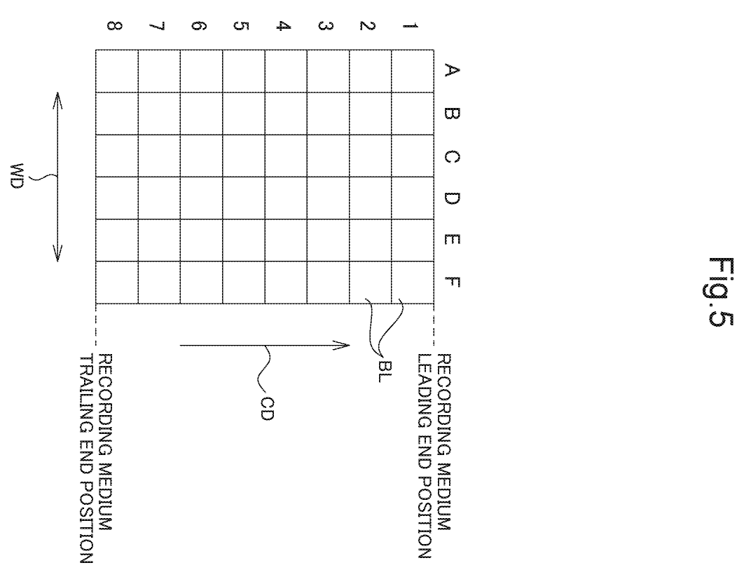

The counting device 101 counts the number of dots (an image density) based on the image data for each of a plurality of blocks formed by dividing the image data to be printed in the transport direction of the recording medium P and a width direction perpendicular to the transport direction. For example, the counting device 101 analyzes the image data for each page, and as shown in the example in FIG. 5, divides the image data into rectangular blocks BL with 8 rows (rows 1 to 8) in the transport direction CD (a vertical direction in FIG. 5) and 6 columns (columns A to F) in the width direction WD (horizontal direction in FIG. 5), and counts the number of dots for each of the blocks BL. For ease of explanation, a case in which the number of blocks is 48 (=6×8) is shown here, but it is preferable to further reduce a size of each of the blocks BL and increase the number of blocks BL. In particular, it is better to have a larger number of rows which are divided in the transport direction CD.

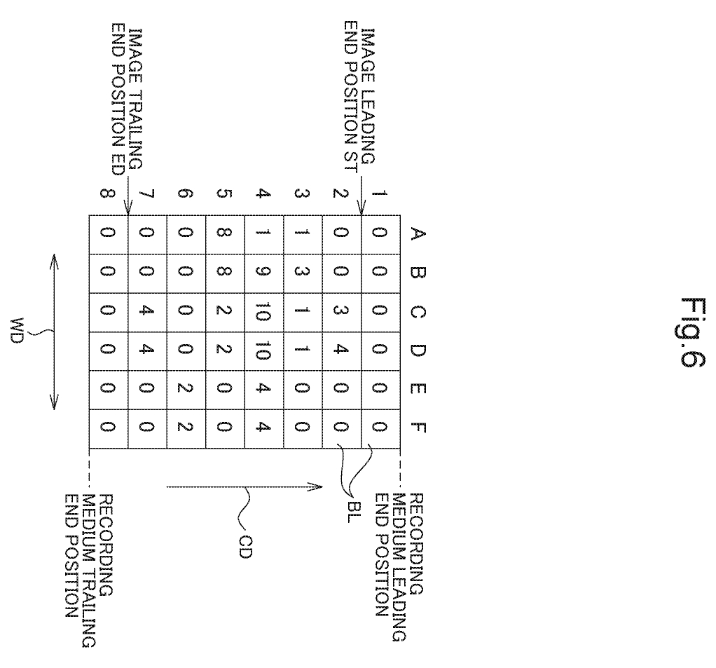

FIG. 6 is a diagram showing an example of an image formed on the recording medium P, which is expressed in terms of the number of dots. All values in the blocks BL in row 1 are “0,” but in row 2, the values in the blocks BL in columns C and D are greater than or equal to “1.” Therefore, a boundary between rows 1 and 2 is an image leading end position ST.

In addition, all the values in the blocks BL of the last row (row 8) are “0,” but in row 7, the values in the blocks BL of columns C and D are “1” or greater. Therefore, a boundary between rows 7 and 8 is an image trailing end position ED.

Based on the image data, the identification device 102 identifies the image leading end position ST on the recording medium P located downstream in the transport direction CD with respect to the leading end of the recording medium P in the transport direction CD, and the image trailing end position ED on the recording medium P located upstream in the transport direction CD with respect to the trailing end of the recording medium P in the transport direction CD. For example, the identification device 102 determines a position at which a predetermined number of dots or more are present in a data portion corresponding to a corresponding region on a recording medium based on the number of dots in the block BL counted by the counting device 101 and the image data to be used for image formation by the image forming device 12, and identifies the image leading end position ST and the image trailing end position ED on the recording medium P based on the position at which a certain number of dots or more are present in the data portion.

The controller 100 adjusts a timing at which the electric charge supply device 49 starts supplying electric charge to the surface (the above-described contact surface) of the fixing belt 41 to match a timing at which the image leading end position ST identified by the identification device 102 arrives at the fixing nip N, and adjusts a timing at which the electric charge supply device 49 stops supplying the electric charge to the surface (the above-described contact surface) of the fixing belt 41 to match a timing at which the image trailing end position ED identified by the identification device 102 arrives at the fixing nip N. The controller 100 sets a current value of the constant current of the voltage application unit 56 of the electric charge supply device 49 to 0 until a timing to start supplying electric charge arrives, and sets the current value of the constant current of the voltage application unit 56 of the electric charge supply device 49 to the above-described target current value when the timing to start supplying electric charge arrives.

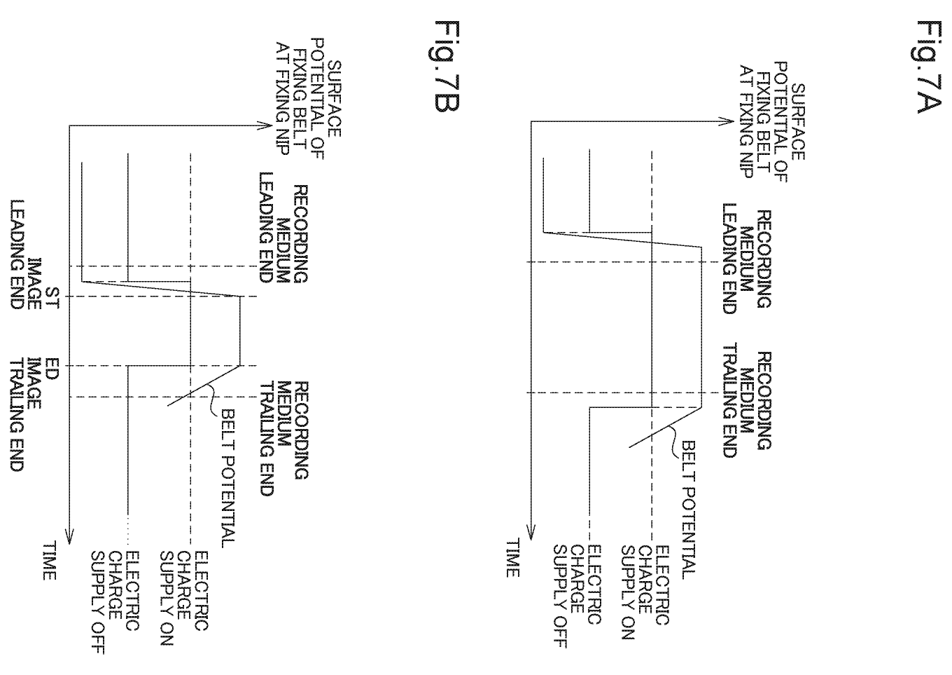

FIGS. 7A and 7B are diagrams showing an example of a change in a surface potential of the fixing belt 41 at the fixing nip N. FIG. 7A shows a comparative example that is not the present embodiment, and shows a case in which the supply of electric charge to the surface of the fixing belt 41 is started (electric charge supply ON) based on the leading end position of the recording medium P, and the supply of electric charge to the surface of the fixing belt 41 is ended (electric charge supply OFF) based on the trailing end position of the recording medium P. FIG. 7B shows a case in which, in this embodiment, the supply of electric charge to the surface of the fixing belt 41 is started (electric charge supply ON) in accordance with the timing when the image leading end position ST arrives at the fixing nip N, and the supply of electric charge to the surface of the fixing belt 41 is ended (electric charge supply OFF) in accordance with the timing when the image trailing end position ED arrives at the fixing nip N. When the timing for ending the supply of electric charge arrives, the controller 100 changes the current value of the constant current of the voltage application unit 56 of the electric charge supply device 49 from the target current value to 0, so that the electric charge supply device 49 does not supply electric charge.

As shown in FIG. 7A and 7B, starting or ending the supply of electric charge to the surface of the fixing belt 41 in accordance with the timing at which the image leading end position ST and the image trailing end position ED arrive at the fixing nip N can shorten an electric charge supply time and reduce the amount of supply of electric charge.

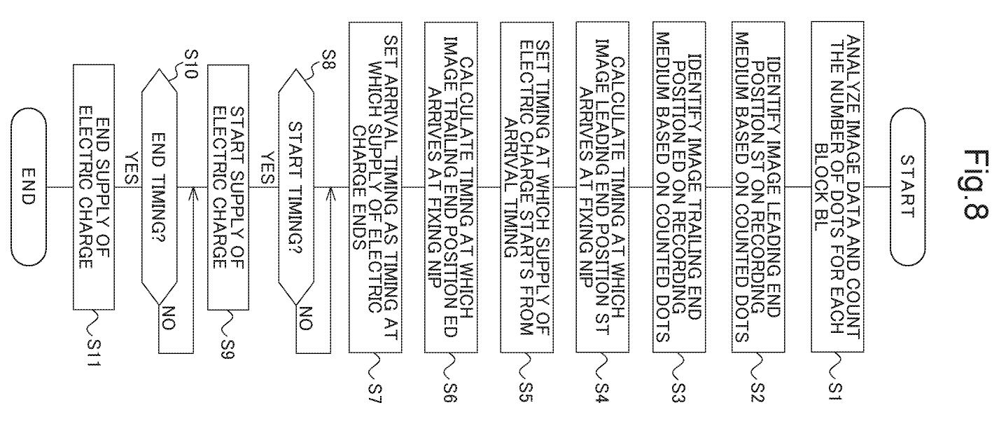

Next, an example of a process related to the supply of electric charge to the surface of the fixing belt 41, which is performed by the control unit 10 of the image forming apparatus 1, will be described with reference to a flowchart shown in FIG. 8.

The counting device 101 analyzes image data for one page of a document to be printed, and counts the number of dots based on the image data for each of the plurality of blocks BL (S1). The identification device 102 identifies the image leading end position ST and the image trailing end position ED on the recording medium P based on the number of dots in the block BL counted by the counting device 101 (S2 and S3).

The controller 100 calculates a timing at which the image leading end position ST identified by the identification device 102 arrives at the fixing nip N (S4), and sets the timing to start supplying electric charge from the calculated arrival timing (S5). For example, the controller 100 sets the start timing to B seconds before the timing when the image leading end position ST arrives at the fixing nip N.

The identification device 102 identifies the image leading end position ST and the image trailing end position ED on the recording medium P, and calculates a distance D1 between the image leading end position ST and the leading end position of the recording medium P based on this identification. Therefore, the controller 100 calculates a timing at which the image leading end position ST arrives at the fixing nip N based on the arrival time at which the leading end position of the recording medium P arrives at the fixing nip N, the process speed (the transport speed of the recording medium P), and the distance D1. The arrival time at which the leading end of the recording medium P arrives at the fixing nip N is calculated by the controller 100 from the distance from the above-described predetermined position (the position at which the presence/absence detection sensor 152 is located; the position at which the recording medium is detected by the presence/absence detection sensor 152) to the fixing nip N and the process speed.

Next, the controller 100 calculates the timing at which the image trailing end position ED identified by the identification device 102 arrives at the fixing nip N (S6), and sets the calculated arrival timing as an end timing of the supply of electric charge supply (S7).

The identification device 102 identifies the image leading end position ST and the image trailing end position ED on the recording medium P, and calculates a distance D2 between the image trailing end position ED and the trailing end position of the recording medium P based on this identification. Therefore, the controller 100 calculates a timing at which the image trailing end position ED arrives at the fixing nip N based on the arrival time at which the trailing end position of the recording medium P arrives at the fixing nip N, the process speed, and the distance D2. The arrival time when the trailing end position of the recording medium P arrives at the fixing nip N is calculated by the controller 100 from a distance from the predetermined position to the fixing nip N and the process speed.

The controller 100 determines whether it is time to start the supply of electric charge (S8), and when it determines that it is time to start the supply of electric charge (YES in S8), the controller 100 sets the current value of the constant current of the voltage application unit 56 to the target current value and supplies electric charge to the surface of the fixing belt 41 (S9).

The controller 100 determines whether it is time to end the supply of electric charge (S10), and when it determines that it is time to end the supply of electric charge (YES in S10), the controller 100 sets the current value of the constant current of the voltage application unit 56 to 0 and ends the supply of electric charge to the surface of the fixing belt 41 (S11). Then, the process ends.

Generally, when the amount of supply of electric charge to the fixing unit is excessive, toner components may adhere to the electric charge supply device, causing deterioration of the electric charge supply device and shortening a life of the electric charge supply device. Furthermore, when the amount of supply of electric charge to the fixing unit is excessive, harmful substances such as ultra fine particles (UFP) may be generated.

Therefore, a general technique is known that curbs the excessive supply by adjusting the amount of supply of electric charge to the contact surface based on a minimum value of an area of a toner region that comes into contact with the contact surface of the fixing unit with the recording medium.

However, in the above-described general technology, since the electric charge is supplied to regions in which no toner image is formed (that is, regions in which the supply of electric charge is not required), the excessive supply is not sufficiently curbed.

In contrast, according to the above embodiment, the supply of electric charge to the contact surface of the fixing belt 41 with the recording medium P starts and ends in accordance with the arrival of the image leading end position ST and the image trailing end position ED on the recording medium P at the fixing nip N, thereby curbing the supply of electric charge to regions in which the supply of electric charge is not required. Therefore, while ensuring the necessary charging of the contact surface of the fixing belt 41 with the recording medium P, it is possible to reduce the amount of electric charge supplied to the contact surface of the fixing belt 41 with the recording medium P, thereby further curbing the deterioration of the electric charge supply device 49 and the generation of harmful substances.

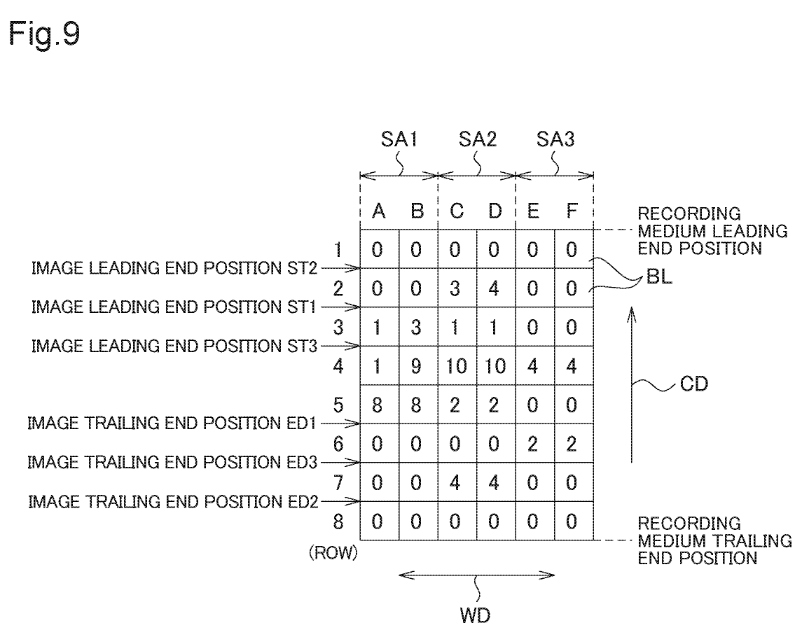

In another embodiment, the electric charge supply device 49 is provided for each of the divided regions obtained by dividing the surface of the fixing belt 41 into a plurality of regions in the axial direction of the rotation axis of the fixing belt 41 (the width direction of the recording medium P), the identification device 102 identifies the image leading end position ST and the image trailing end position ED for each of the divided regions, and the controller 100 adjusts the timing at which each of the electric charge supply devices 49 starts and stops the supply of electric charge to the surface of the fixing belt 41 for each of the divided regions. For example, when three electric charge supply devices 49 are separately provided for three divided regions SA1 to SA3 in the axial direction of the rotation axis of the fixing belt 41, the identification device 102 identifies the image leading end position ST and the image trailing end position ED for each of the divided regions SA1 to SA3, as shown in the example of FIG. 9.

The identification device 102 determines, for each of the divided regions SA1 to SA3, a position at which a predetermined number of dots or more are present in a data portion corresponding to a corresponding region on the recording medium, based on the number of dots in the block BL counted by the counting device 101 and the image data to be used for image formation by the image forming device 12, and identifies the image leading end position ST and the image trailing end position ED on the recording medium P for each of the divided regions SA1 to SA3 based on the position at which the predetermined number of dots or more are present in the data portion.

In the example shown in FIG. 9, the identification device 102 identifies a boundary between row 2 and row 3 in the divided region SA1 as the image leading end position ST1, and a boundary between row 5 and row 6 as the image trailing end position ED1, and in the divided region SA2, the identification device 102 identifies a boundary between row 1 and row 2 as the image leading end position ST2, and a boundary between row 7 and row 8 as the image trailing end position ED2. In the divided region SA3, the identification device 102 identifies a boundary between row 3 and row 4 as the image leading end position ST3, and a boundary between row 6 and row 7 as the image trailing end position ED3. Based on this identification, the controller 100 adjusts the timing at which each of the electric charge supply devices 49 starts and stops the supply of electric charge to the surface of the fixing belt 41 for each of the divided regions. Thus, the amount of electric charge supplied to the contact surface with the recording medium P can be further reduced while ensuring the necessary charging on the fixing belt 41.

The present disclosure is not limited to the configuration of the above-described embodiment, and various modifications are possible. Furthermore, the configurations and processes of the above-described embodiment shown in FIGS. 1 to 9 are merely one embodiment of the present disclosure, and are not intended to limit the present disclosure to these configurations and processes.

While the present disclosure has been described in detail with reference to the embodiments thereof, it would be apparent to those skilled in the art that the various changes and modifications may be made therein within the scope defined by the appended claims.

What is claimed is:

1. An image forming apparatus comprising:
an image forming device configured to form a toner image on a recording medium based on image data;
a fixing unit provided to be rotatable and configured to come into contact with the recording medium on which the toner image is formed to heat the recording medium;
a pressure unit configured to form a fixing nip between the fixing unit and the pressure unit, in which the recording medium is sandwiched and transported, and configured to drive and rotate the fixing unit;
an electric charge supply device provided to face a contact surface of the fixing unit with the recording medium and configured to supply an electric charge having the same polarity as the charge polarity of the toner contained in the toner image to the contact surface; and
a control unit including a processor, and, by the processor executing a control program, configured to function as:
a controller that controls an amount of electric charge supplied by the electric charge supply device and supplies an electric charge to the contact surface; and
an identification device that identifies, based on the image data, a leading end position of an image formed on the recording medium located downstream in a transport direction of the recording medium relative to a leading end of the recording medium in the transport direction, or a trailing end position of the image formed on the recording medium located upstream in the transport direction of the recording medium relative to a trailing end of the recording medium in the transport direction,
wherein the controller controls an amount of electric charge supplied by the electric charge supply device to adjust a timing at which the electric charge supply device starts supply of the electric charge to the contact surface to match a timing at which the leading end position of the image identified by the identification device arrives at the fixing nip, or to adjust a timing at which the electric charge supply device stops the supply of the electric charge to the contact surface to match a timing at which the trailing end position of the image identified by the identification device arrives at the fixing nip.

2. The image forming apparatus according to claim 1, wherein the electric charge supply device is provided for each of divided regions formed by dividing the contact surface in an axial direction of a rotation axis of the fixing unit,
the identification device identifies the leading end position of the image for each of the divided regions, and
the controller adjusts a timing at which each of the electric charge supply devices starts the supply of the electric charge to the contact surface for each of the divided regions.

3. The image forming apparatus according to claim 1, wherein the electric charge supply device is provided for each of the divided regions formed by dividing the contact surface in an axial direction of a rotation axis of the fixing unit,
the identification device identifies a trailing end position of the image for each of the divided regions, and
the controller adjusts a timing at which each of the electric charge supply devices stops the supply of the electric charge to the contact surface for each of the divided regions.

4. The image forming apparatus according to claim 1, wherein the controller controls an amount of electric charge supplied to the contact surface by controlling a voltage applied to an electric discharge electrode of the electric charge supply device so that a current value flowing through the electric discharge electrode becomes a predetermined target current value.

5. The image forming apparatus according to claim 4, wherein when the supply of the electric charge by the electric charge supply device stops, the controller sets a value of the current flowing through the electric discharge electrode to 0, thereby stopping the supply of the electric charge to the contact surface.
